(19) United States
(12) Patent Application Publication
(10) Pub. No.: US 2012/0162445 A1
(43) Pub. Date: Jun. 28, 2012

(54) VIRTUAL TUNNEL ROUTER, IP CAMERA MANAGEMENT SERVER AND LOCATION-BASED IP CAMERA SERVICE METHOD

(75) Inventors: Sun-Cheul KIM, Daejeon-si (KR); Young-Soo SHIN, Daejeon-si (KR); Sang-Jin HONG, Goyang-si (KR); Jung-Sik KIM, Daejeon-si (KR); Ho-Yong RYU, Daejeon-si (KR)

(73) Assignee: ELECTRONICS AND TELECOMMUNICATIONS RESEARCH INSTITUTE, Daejeon-si (KR)

(21) Appl. No.: 13/333,187

(22) Filed: Dec. 21, 2011

(30) Foreign Application Priority Data
Dec. 22, 2010 (KR) 10-2010-0132729

(51) Int. Cl. H04N 5/225

(52) U.S. Cl. 348/207.1; 348/E05.024

(57) ABSTRACT

A virtual tunnel router, an IP camera management server, and a location-based Internet protocol (IP) camera service are provided. Without complex equipment, a direct communication between a user terminal and an IP camera is established based on virtual IP, and thus control of the IP camera is very simple and a user is allowed to directly access the IP camera at any time and any place.

### CROSS-REFERENCE TO RELATED APPLICATION(S)

This application claims the benefit under 35 U.S.C. §119(a) of Korean Patent Application No. 10-2010-0132729, filed on Dec. 22, 2010, in the Korean Intellectual Property Office, the entire disclosure of which is incorporated herein by reference for all purposes.

### BACKGROUND

1. Field

The following description relates to an Internet protocol (IP) camera control and service technology, and more particularly, to a virtual tunnel router, an IP camera management server, and a location-based IP camera service method for IP camera control.

2. Description of the Related Art

A recent IP network generally employs a firewall or network address translation (NAT) to block unauthorized access from an external network or due to lack of IP, resulting in difficulties in a direct communication between IP devices. Hence, a majority of current IP services are server-based communication services such as World Wide Web and/or session initiation protocol (SIP)-based communication services.

Similarly, it is difficult for users to directly access IP cameras and to receive image/audio services when a private IP address connected to NAT or a public IP address involved with a firewall in a company network. Hence, only limited image/audio services are available in association with an IP camera control system or a centralized server.

To enable a direct communication with an IP camera, a signaling server is required to be designed to relay ‘STUN/UDP Hole Punching’ and the like to a public network, and each user terminal should have software that is associated with the signaling server. Moreover, the user terminal is essentially associated with application layer gateway equipment according to network configuration. Accordingly, complex network techniques are required, and installation and management incur quite high costs.

Hence, a research on technologies for providing IP camera services easily at a low cost through a network which is established between a user terminal and an IP camera without expensive and complex equipment such as a signaling server, for example, STUN/UDP Holepunching, ALG, or the like are carried out.

### SUMMARY

In one general aspect, there is provided a virtual tunnel router including: a connection setting unit configured to an IP-(UDP-TCP)-IP tunnel to another virtual tunnel router; a direct communication establishing unit configured to establish a direct communication to an Internet protocol (IP) camera in another network by exchanging virtual network prefix information with the other virtual tunnel router connected by the connection setting unit. In one general aspect, there is provided an Internet protocol (IP) camera management server including: a camera information managing unit configured to store and manage information about IP cameras in a virtual network; and a camera searching unit configured to, in response to an IP camera search request from a user terminal in the virtual network, search for information about the requested IP camera from the stored IP camera information and to provide the found IP camera information to the user terminal.

In another general aspect, there is provided a location-based IP camera service method including: transmitting user location information from a user terminal to a location management server; at the location management server, searching for an IP camera closest to the transmitted user location information with reference to camera location information stored in an IP camera management server; and providing IP camera information about the IP camera found by the location management server to the user terminal.

Other features and aspects may be apparent from the following detailed description, the drawings, and the claims.

### BRIEF DESCRIPTION OF THE DRAWINGS

FIG. 1 is a diagram illustrating an example of a virtual network for an Internet protocol (IP) camera control.

FIG. 2 is a block diagram illustrating an example of a virtual tunnel router.

FIG. 3 is a flowchart illustrating an example of procedures of the virtual tunnel router shown in FIG. 2 to register a virtual network.

FIG. 4 is a block diagram illustrating an example of an IP camera management server.

FIG. 5 is a flowchart illustrating an example of procedures of the IP camera management server shown in FIG. 4 which searches for an IP camera.

FIG. 6 is a flowchart illustrating another example of procedures of the IP camera management server searching for an IP camera.

FIG. 7 is a flowchart illustrating an example of a location-based IP camera service method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

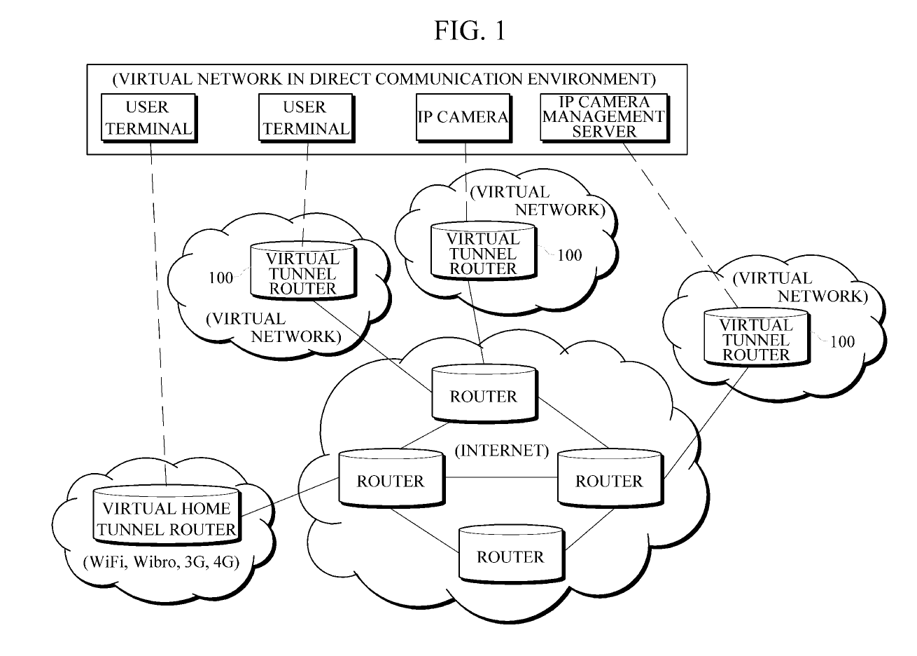

FIG. 1 illustrates a diagram of an example of a virtual network for an Internet protocol (IP) camera control. As illustrated in FIG. 1, multiple virtual networks may be formed by a number of virtual tunnel routers 100.

Each virtual tunnel router 100 may access existing routers, and access a general user terminal, a switch or Ethernet port which an IP camera accesses, or a wireless network (e.g., WiFi, WiMax, 3G, or 4G networks). In addition, each virtual tunnel router 100 may access a network associated with firewall or NAT.

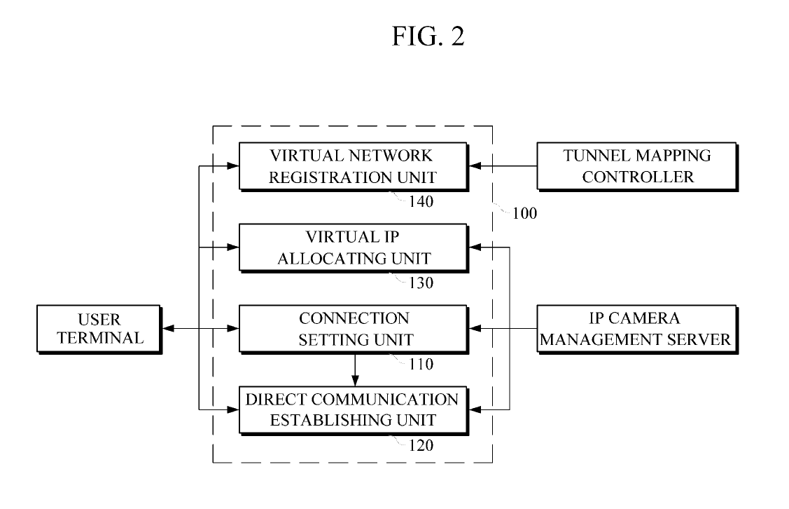

FIG. 2 illustrates a block diagram of an example of a virtual tunnel router. As illustrated in FIG. 2, the virtual tunnel router 100 may be implemented in a software or hardware manner, or in a software and hardware combined manner, and may include a connection setting unit 110 and a direct communication establishing unit 120.

The connection setting unit 110 may build an IP-(UDP-TCP)-IP tunnel between the virtual tunnel router 100 and another virtual tunnel router. The direct communication establishing unit 120 may exchange virtual network prefix with the other virtual tunnel network and establish direct communication with an IP camera on the other virtual network.

The virtual tunnel routers 100 may function as network components that form one or more virtual networks, and each may use the connection setting unit 110 to set an IP-(UDP-TCP)-IP tunnel with another virtual tunnel router and may use the direct communication establishing unit 120 to exchange virtual network prefix information with the other virtual tunnel router and thereby to allow a user terminal belonging to the corresponding virtual network to direct communicate with an IP camera on the other virtual network.

In another example, the virtual tunnel router 100 may further include a virtual IP allocating unit 130. The virtual IP allocating unit 130 may allocate a virtual IP address to the user terminal or an IP camera on the same virtual network as the virtual IP allocating unit 130.

To explain a method of allocating a virtual IP address to the user terminal or the IP camera, it is assumed that pieces of information of each IP camera, such as camera identifier information, virtual IP information, camera type information, camera description information, is camera location information, and the like, are stored in an IP camera management server which will be described later.

One method of IP allocation is to manually set an IP address, and another method is to automatically allocate a virtual IP address through the virtual IP allocating unit 130. When a virtual IP address is automatically allocated, dynamic host configuration protocol (DHCP) may be employed.

In allocation of a virtual IP using DHCP, a fixed IP should be allocated to a DHCP server using such information as MAC so as to enable a previously specified virtual IP to be allocated to the user terminal or the IP camera.

In this case, the virtual tunnel router 100 functions as a DHCP relay, and the IP camera management server functions as a DHCP server. Regardless of the fact whether the IP allocation is carried out manually or automatically, the user terminal or the IP camera is required to be allocated a previously specified virtual IP address that is included in the information of the IP camera.

The virtual IP allocating unit 130 may allocate a private IP address as a virtual IP address. For the IP-(UDP-TCP)-IP tunnel set by the connection setting unit 110, an IP address used by an inner header is a virtual IP address, and may be either IPv4 address or IPv6 address.

The virtual IP address may function as an unchangeable identifier for identifying the user terminal or the IP camera on the virtual network. The user terminal or the IP camera that accesses the virtual tunnel router 100 is allocated the virtual IP address by the virtual IP allocating unit 130.

In configuring an IP camera network, it is difficult to allocate a common IP address to a large number of IP cameras since currently IPv4 addresses are in short supply, and a cost is problem may arise. To solve such problems, a private IPv4 address may be used as a virtual IP address.

In a case in which IPv6 is used as virtual IP, an IPv6 network-based IP camera network is configured to enable access to IPv6 via an existing IPv4 network.

In another example, the virtual tunnel router 100 may further include a virtual network registration unit 140. The virtual network registration unit 140 may register a virtual network to manage in a tunnel mapping controller.

The tunnel mapping controller may manage the IP-(UDP-TCP)-IP tunnel for setting a session between virtual networks, and may be implemented in the IP camera management server or in a particular virtual tunnel router.

In this case, the virtual network registration unit 140 may request the tunnel mapping controller to allocate a previously specified virtual network prefix address pool, and receive the virtual network prefix address pool from the tunnel mapping controller.

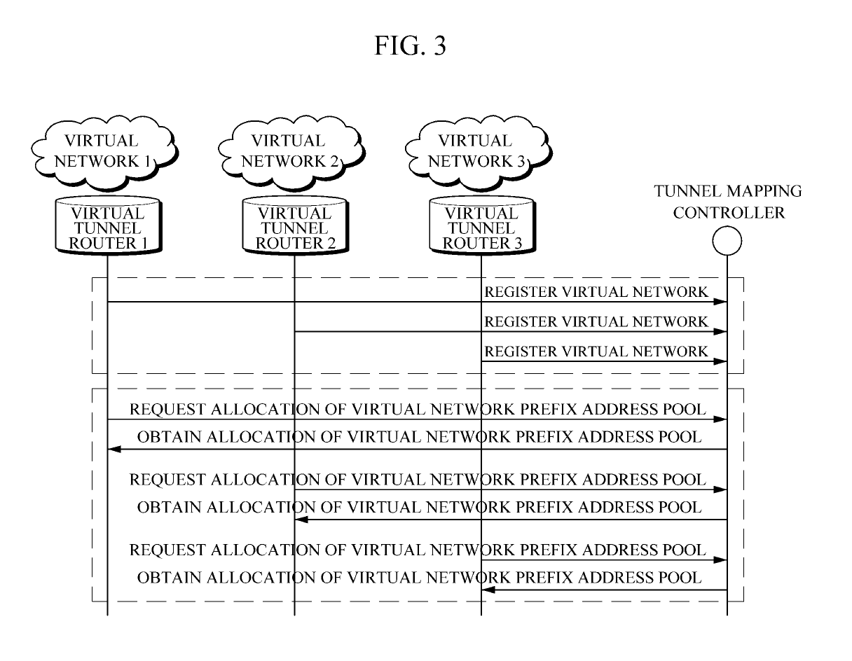

FIG. 3 illustrates a flowchart of an example of procedures of the virtual tunnel router shown in FIG. 2 to register a virtual network. As shown in FIG. 3, to configure a virtual IP-based virtual network, the virtual tunnel router 100 uses the virtual network registration unit 140 to a virtual network to manage in the tunnel mapping controller in operation 310, requests the tunnel mapping controller to allocate a previously specified virtual network prefix address pool in operation 320, and obtains the virtual network prefix address pool from the tunnel mapping controller in operation 330.

As a result, a virtual network is configured by the virtual tunnel router 100, and a direct communication between a user terminal and an IP camera which are located in different virtual networks in remote can be established by setting an IP-(UDP-TCP)-IP tunnel.

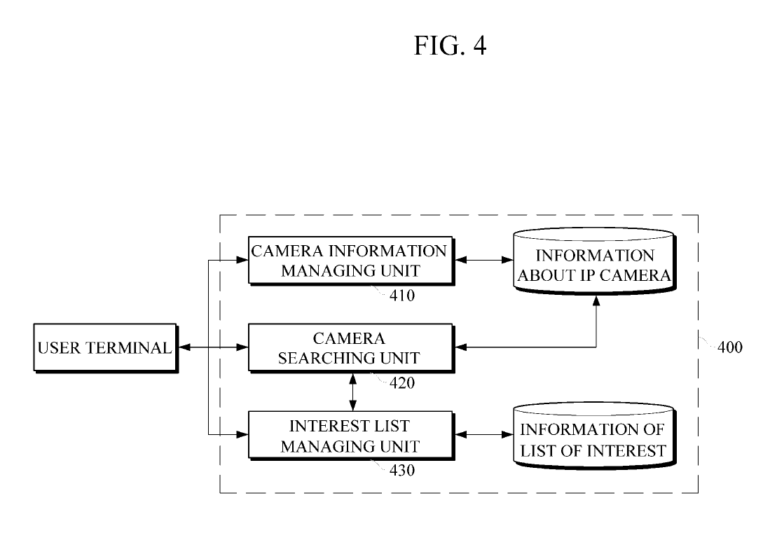

An IP camera management server configuration that manages an IP camera under the is environment where the direct communication between the user terminal and the IP camera is established by the above procedures will be described with reference to FIG. 4. FIG. 4 illustrates a block diagram of an example of an IP camera management server. Referring to FIG. 4, the IP camera management server 400 may include a camera information managing unit 410 and a camera searching unit 420.

The camera information managing unit 410 may store and mange information about IP cameras on the virtual network. The information about IP cameras may include camera identifier information, virtual IP information, camera type information, camera description information, and camera location information.

In response to an IP camera search request from the user terminal, the camera searching unit 420 may search the camera information managing unit 410 for information about the requested IP camera, and provide the found information to the user terminal.

In another example, the IP camera management server 400 may further include an interest list managing unit 430. The interest list managing unit 430 may store and manage a list of IP cameras that each user is interested in. The list of IP cameras of interest may include information of identifier of an IP camera that has been frequently searched for, or virtual IP information of the IP camera.

The IP camera management server 400 may provide the list of IP cameras of interest to the user terminal when the user terminal accesses the network, and the user may be allowed to directly communicate with an IP camera included in the list, and thereby being easily provided with still images or videos of the interested IP camera.

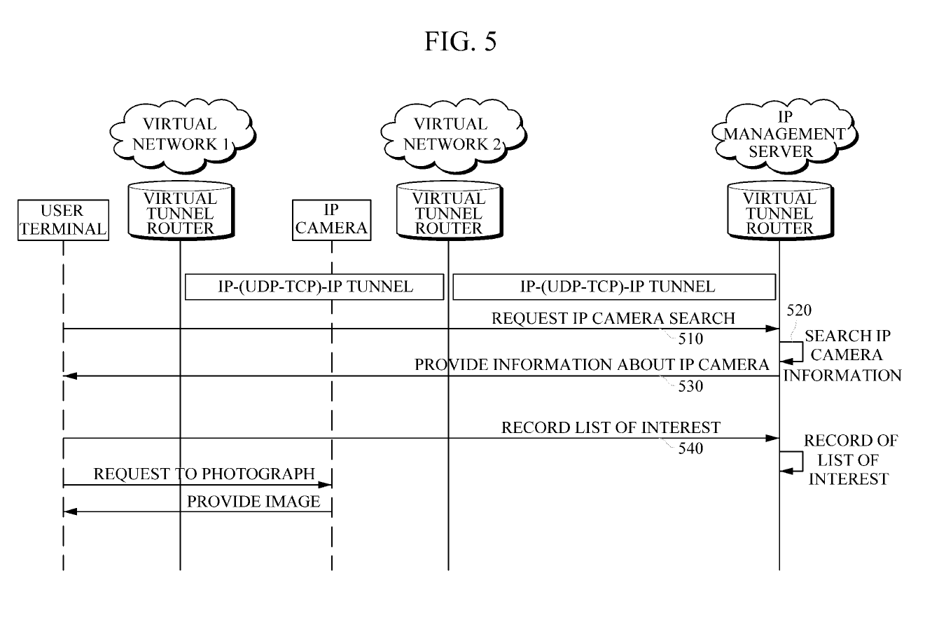

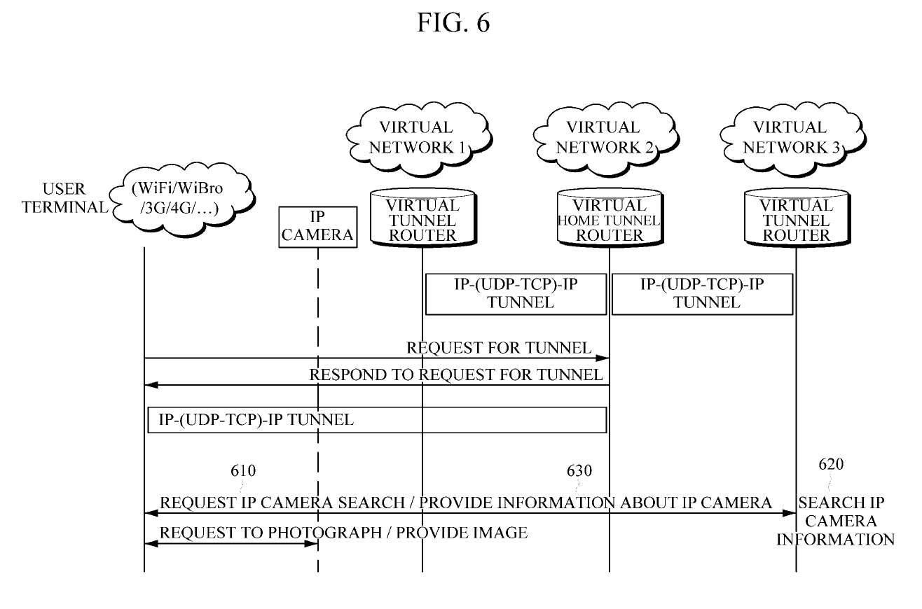

Operation of the IP camera management server 400 searching for an IP camera will be described with reference to FIGS. 5 and 6. FIG. 5 illustrates a flowchart of an example of is procedures of the IP camera management server which is shown in FIG. 4 and searches for an IP camera in response to an IP camera search request from a user terminal on the virtual network. FIG. 6 illustrates a flowchart of an example of procedures of the IP camera management server searching for an IP camera in response to an IP camera search request from a user terminal on a non-virtual network.

It is assumed that an IP-(UDP-TCP)-IP tunnel is established between a virtual tunnel router on the same virtual network as the user terminal and a virtual tunnel router on the same virtual network as the IP camera management server.

Moreover, it is assumed that the IP camera management server stores information about each IP camera including camera identifier information, virtual IP information, camera type information, camera description information, and camera location information.

A user drives an IP camera client using the user terminal belonging to a virtual terminal to request IP camera search in operation 510.

In operation 520, the IP camera management server searches for information about the requested IP camera from the previously stored information about each IP camera.

The IP camera management server provides the found IP camera information to the relevant user terminal in operation 530.

The user may check the provided IP camera information, and if necessary, may record the found IP camera in an interest list managed by the IP camera management server in operation 540.

Accordingly, the user checks the provided IP camera information and makes an access to the relevant IP camera through a direct communication, and thereby being easily provided with still images or video services from the IP camera of interest.

Thus, the user is allowed to be provided with still images or video services from each IP is camera through a direction communication without a dedicated server or equipment for signaling or media data processing for audio/image data.

On the other hand, the user may manage information of IP cameras in such as way as stores and manages a friend list in a messenger program without searching for an IP camera each time, and may be conveniently provided with video services from the IP camera included in an interest list.

FIG. 6 illustrates a flowchart of another example of procedures of the IP camera management server which is shown in FIG. 4 and searches for an IP camera. In the example illustrated in FIG. 6, a user terminal is inevitably unable to be present in a virtual network due to a business trip or the like and is present in a non-virtual network. Thus, the user terminal is required to establish an IP-(UDP-TCP)-IP tunnel between a virtual tunnel router of the user terminal itself and a virtual tunnel router of a virtual network in which the IP camera management server is present.

A virtual home tunnel router refers to a virtual tunnel router that is previously specified for a user terminal to access when a user initially configures a virtual network. A tunneling client is driven using the user terminal to establish an IP-(UDP-TCP)-IP tunnel between the virtual home tunnel router and the virtual tunnel router in the virtual network in which the IP camera management server is present, and virtual network prefix information is obtained, and thereby the user terminal is enabled to join the virtual network.

Procedures after the IP-(UDP-TCP)-IP tunnel has been established between the virtual home tunnel router and the virtual tunnel router of the virtual network in which the IP camera management server are the same as procedures as shown in FIG. 5.

More specifically, when the user drives the IP camera client using the user terminal to request IP camera search in operation 610, the IP camera management server searches for is information about the requested IP camera from previously stored IP camera information in operation 620 and provides the found IP camera information to the user terminal in operation 630. The user confirms the provided IP camera information, and if necessary, may record the IP camera information in an interest list managed by the IP camera management server.

Accordingly, the user is allowed to access the relevant IP camera via a direct communication based on the provided IP camera information, and is enabled to be easily provided with still images or video services from the IP camera that the user has interest in.

In other words, the user can be provided with the still images or video services through a direct communication with the IP camera without a dedicated server or equipment for signaling or processing media data such as audio/video data.

On the other hand, the user may manage IP cameras using an interest list in such a way that stores and manages a friend list in a messenger program without searching for IP cameras each time required, and may be easily provided with video services from the IP camera included in the interest list.

This method allows a user terminal such as a smart phone or a laptop to directly communicate with the IP camera management server through the virtual home tunnel router and be provided with an IP camera service when the user terminal is in access to a network that is not a virtual network including WiFi, Wibro, 3G and 4G networks.

As described above, the present invention may allow IP cameras which are distributed over a school, a kindergarten, an intersection, a playground area, and the like to build direct communication environments between the distributed IP camera networks, and thus without a high-priced equipment such as ALG that processes a variety of signaling and media data, easy and convenient IP camera services can be provided only by operating an IP camera management server that only manages IP camera information. Thus, the IP camera network configuration is can be simplified, thereby establishing an IP camera network at a low cost.

In addition, through a virtual IP-based direct communication environment, the user may be able to be provided with an IP camera service and easily control the IP camera by accessing the IP camera directly at any time and any place.

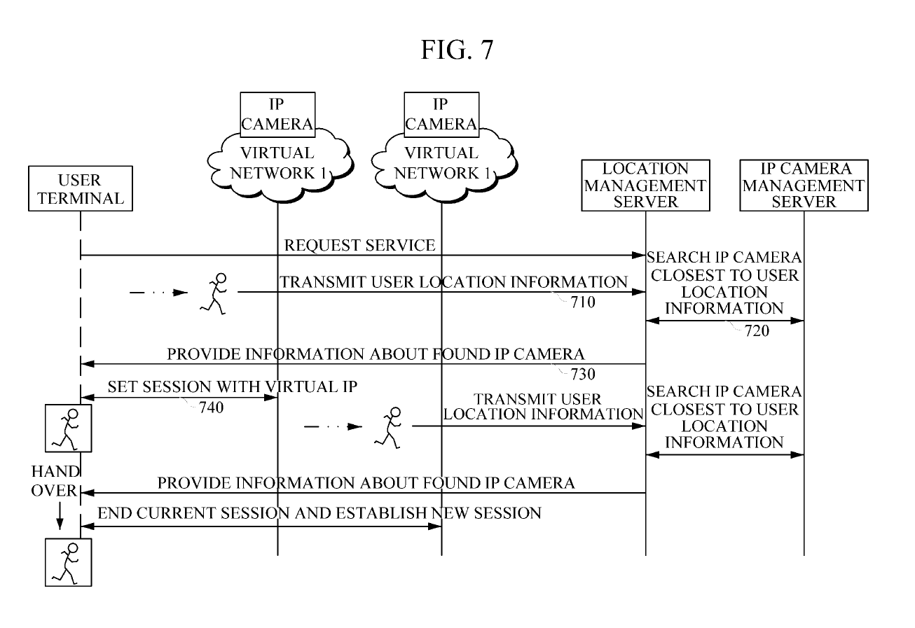

Procedures of the IP camera management server provides an IP camera service based on a location of the user terminal will be described with reference to FIG. 7. FIG. 7 illustrates a flowchart of an example of a location-based IP camera service method.

In operation 710, the user terminal transmits user location information to a location management server. In this case, the user terminal may periodically transmit the user location information to the location management server. The user location information may be acquired by a global positioning system (GPS) module embedded in the user terminal.

In operation 720, the location management server searches for an IP camera whose location information is closest to the transmitted user location information with reference to camera location information stored in the IP camera management server. In this case, the location management server and the IP camera management server may be the same each other or may be apart from each other.

The IP camera management server may previously store information about IP cameras, including camera identifier information, virtual IP information, camera description information, camera location information, and the like. In operation 720, the location management server may compare the camera location information stored in the IP camera management server to the user location information to search for an IP camera closest to the user location information.

Thereafter, in operation 730, the location management server provides information about the IP camera found in operation 720 to the user terminal. For example, the IP camera information may include camera identifier information, virtual IP information, camera type information, camera description information, and camera location information.

As another example, session setting may be performed in operation 740. In operation 740, the user terminal sets a session with a virtual IP address included in the IP camera information which has been provided in operation 730.

In this case, if camera identifier information included in currently received IP camera information is different from camera identifier information included in previously received IP camera information, the user terminal may end the current session and establish a new session with a virtual IP address of an IP camera included in the currently received IP camera information.

On the other hand, if the camera identifier information included in the currently received IP camera information is the same as the camera identifier information included in the previously received IP camera information, the user terminal may maintain the current session in operation 740. By doing so, handover of the user terminal from one IP camera to another may be realized.

Moreover, as another example, photographing may be further performed in operation 750. In operation 750, the user terminal requests the IP camera having a session set in operation 740 to photograph, and receives an image photographed by the IP camera.

As such, the user terminal is provided with the information about the IP camera closest to the user terminal, the session is connected by direct communication between the user terminal and the closest IP camera, and the image photographed by the session-connected IP camera, and thus the user terminal can be provided with IP camera services by directly accessing the IP camera at any time and any place based on the user location under the virtual IP-based direct communication environment.

As described above, the present invention establishes a direct communication environment between a user terminal and an IP camera based on virtual IP without complex equipment, thereby configuring an IP camera network at a low cost, providing a simple control of an IP camera, and allowing a user to directly access the IP camera at any time and any place.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A virtual tunnel router comprising:
a connection setting unit configured to an IP-(UDP-TCP)-IP tunnel to another virtual tunnel router;
a direct communication establishing unit configured to establish a direct communication to an Internet protocol (IP) camera in another network by exchanging virtual network prefix information with the other virtual tunnel router connected by the connection setting unit.

2. The virtual tunnel router of claim 1, further comprising:
a virtual IP allocating unit configured to allocate a virtual IP address of a user terminal or an IP camera in the same network.

3. The virtual tunnel router of claim 2, wherein the virtual IP allocating unit is is further configured to allocate a private IP address as a virtual IP address.

4. The virtual tunnel router of claim 1, further comprising:
a virtual network registration unit configured to register a virtual network to be managed to a tunnel mapping controller.

5. The virtual tunnel router of claim 4, wherein the virtual network registration unit is further configured to request the tunnel mapping controller to allocate previously specified virtual network prefix address pool, and to obtain the virtual network prefix address pool from the tunnel mapping controller.

6. An Internet protocol (IP) camera management server comprising:
a camera information managing unit configured to store and manage information about IP cameras in a virtual network; and
a camera searching unit configured to, in response to an IP camera search request from a user terminal in the virtual network, search for information about the requested IP camera from the stored IP camera information and to provide the found IP camera information to the user terminal.

7. The IP camera management server of claim 6, wherein the information about IP cameras which are managed by the camera information managing unit includes camera identifier information, virtual IP information, camera type information, camera description information, and camera location information.

8. The IP camera management server of claim 6, wherein the IP camera management server is further configured to comprise an interest list management unit configured to store and manage a list of IP cameras that each user are interested in.

9. A location-based IP camera service method comprising:
transmitting user location information from a user terminal to a location management server;
at the location management server, searching for an IP camera closest to the transmitted user location information with reference to camera location information stored in an IP camera management server; and
providing IP camera information about the IP camera found by the location management server to the user terminal.

10. The location-based IP camera service method of claim 9, wherein the transmitting of the location information comprises transmitting the user location information periodically from the user terminal to the location management server.

11. The location-based IP camera service method of claim 9, wherein the user location information is obtained by a global positioning system (GPS) module embedded in the user terminal.

12. The location-based IP camera service method of claim 9, further comprising:
setting a session with a virtual IP address included in the provided IP camera information.

13. The location-based IP camera service method of claim 12, further comprising:
issuing, at the user terminal, a photograph request to the IP camera with which the session is set and receiving an image photographed by the IP camera.

14. The location-based IP camera service method of claim 12, wherein the setting of the session comprises, if camera identifier information included in currently received IP camera information is different from camera identifier information included in previously received IP camera information, ending, at the user terminal, the current session and establishing a new session with a virtual IP address of an IP camera included in the currently received IP camera information.

15. The location-based IP camera service method of claim 12, wherein the setting of the session comprises, if camera identifier information included in currently received IP camera information is the same as camera identifier information included in previously received IP camera information, maintaining, at the user terminal, the current session.
